(19) United States
(12) Patent Application Publication
(10) Pub. No.: US 2009/0065568 A1
(43) Pub. Date: Mar. 12, 2009

(54) Systems and Methods for Associating Production Attributes with Products

(76) Inventors: Elliott Grant, Redwood City, CA (US); J. Scott Carr, Los Gatos, CA (US); Kevin Ma, San Jose, CA (US); Lin Zhang, Mountain View, CA (US); Jeff Roughgarden, Redwood City, CA (US)

Correspondence Address: PETERS VERNY , L.L.P., 425 SHERMAN AVENUE, SUITE 230, PALO ALTO, CA, 94306, US

(21) Appl. No.: 12/054,654

(22) Filed: Mar. 25, 2008

Related U.S. Application Data
(60) Provisional application No. 60/970,933, filed on Sep. 7, 2007.
(60) Provisional application No. 61/028,163, filed on Feb. 12, 2008.

(51) Int. Cl. G06F 17/00

(52) U.S. Cl. 235/375

(57) ABSTRACT

Methods are provided for marking products with unique identification codes, associating times with at least some of the unique identification codes, and associating other times with certain events pertaining to the production of the marked products. These times can be used to subsequently determine whether a marked product belongs to a population that was produced before or after an event.

### CROSS-REFERENCE TO RELATED APPLICATIONS

This application claims the benefit of U.S. Provisional Patent Application No. 60/970,933 filed on Sep. 7, 2007 and entitled “Attributing Harvest Information with Unique Identifiers” and U.S. Provisional Patent Application No. 61/028,163 filed on Feb. 12, 2008 and entitled “Systems and Methods of Associating Individual Packages with Harvest Crates,” both of which are incorporated herein by reference. This application is related to U.S. patent application Ser. No. 11/619,747 filed on Jan. 4, 2007 and entitled “System and Method of Code Generation and Authentication” which is a Continuation-in-Part of U.S. patent application Ser. No. 11/347,424, filed on Feb. 2, 2006, which claims priority from Provisional U.S. Patent Application No. 60/650,364, filed on Feb. 3, 2005, each of which is incorporated herein by reference.

### BACKGROUND OF THE INVENTION

1. Field of the Invention

The present disclosure relates generally to the field of product manufacturing and distribution and more specifically to systems and methods for tracking individual items.

2. Description of the Prior Art

Presently, various types of identification codes are used to track products in the stream of commerce. These identification codes can be used to determine the source of marked products and in some instances, determine when the products were produced. However, in many instances this alone is insufficient information about a product. In the case of a product recalls, for example, an excessive amount of product is frequently removed from the stream of commerce because not enough information exists to reliably determine which particular units of the products realistically pose a risk. In one recent instance, contaminated bags of spinach prompted the removal of almost all commercially available spinach from the market, even though only a very small fraction of the supply posed any risk to public health. Additionally, the identification codes presently in use on products do not provide much information to the consumer about the history of a product other than the best before date and location of manufacture.

Accordingly, there is a need for systems and methods to provide more information about the histories of products in the marketplace.

### SUMMARY

An exemplary method comprises providing a batch of unique identification codes, marking each of a plurality of products with a unique identification code from the batch, and associating a unique identification code from the batch with a first time. The exemplary method further comprises associating an attribute change with a second time, the attribute characterizing the production of the product and storing the associations.

In various embodiments, providing the batch of unique identification codes includes generating the unique identification codes of the batch and creating a record of the order of the unique identification codes. Providing the batch of unique identification codes can also include providing a roll of labels, each label sequentially including one unique identification code of the batch according to an order of the unique identification codes within the batch. In some of these embodiments, marking each of the plurality of products with the unique identification code from the batch includes affixing a label from the roll to each of the plurality of products. In still other embodiments of the method, providing the batch of unique identification codes includes providing a data file, where the data file includes the unique identification codes and an order of the unique identification codes. In some of these embodiments, marking each of the plurality of products with the unique identification code from the batch includes reading the unique identification codes from the data file and printing or scribing the unique identification codes on each of the plurality of products according to the order.

In other embodiments of the exemplary method, associating the unique identification code from the batch with the first time includes recording when the unique identification code was marked on the product or was read from the product. The method can further comprise associating a delay with the second time and/or associating an uncertainty with the second time. In some embodiments, the method further comprises marking each of a plurality of cases of the products with a unique identification code from a batch different than the batch used to mark the products themselves.

Another exemplary method comprises receiving a unique identification code associated with a product, estimating a time when the product passed a sampling point by comparing the unique identification code to records of the times associated with other unique identification codes from a same batch, and using the estimated time to find a change in an attribute. This exemplary method can also comprise performing an analysis for an irregularity in the records of associations between sampled unique identification codes and the times when those unique identification codes were sampled. In some of these embodiments, estimating the time when the product passed the sampling point further comprises correcting for an irregularity. In further embodiments, the method further comprises generating an estimated time representing when the product passed a production point by adjusting the estimated time for the sampling point by a transit time.

In still other embodiments, using the estimated time to find the change in the attribute includes searching records of associations between times and attribute changes for an attribute change at a time before the estimated time. Using the estimated time to find the change in the attribute can further include adjusting the time of an attribute change by a delay and/or adding an uncertainty to the time of the attribute change.

A machine readable media is also provided having stored thereon a set of instructions. The set of instructions can be executed to cause a machine to perform a method comprising receiving a unique identification code associated with a product, estimating a time when the product passed a sampling point by comparing the unique identification code to records of the times associated with other unique identification codes from a same batch, and using the estimated time to find a change in an attribute.

### BRIEF DESCRIPTION OF DRAWINGS

FIG. 1 shows a flowchart representation of an exemplary method for marking products with unique identification codes and associating those unique identification codes with information about attributes that characterize the production of the products.

FIG. 2 schematically illustrates an exemplary system for performing an embodiment of the method represented by FIG. 1.

FIG. 3 schematically illustrates another exemplary system for performing an embodiment of the method represented by FIG. 1.

FIG. 4 shows a flowchart representation of an exemplary method for using a unique identification code to evaluate an aspect from the history of a product.

FIGS. 5 and 6 show examples of irregularities that may exist in records of associations between sampled unique identification codes and the times when those unique identification codes were sampled.

FIG. 7 shows a timeline for determining product safety during a recall.

### DETAILED DESCRIPTION OF THE INVENTION

The present disclosure is directed to systems and methods for marking products with unique identification codes, associating times with at least some of the unique identification codes, and associating other times with certain events pertaining to the production of the marked products. These times can be used to subsequently determine whether a marked product belongs to a population that was produced before or after an event. Accordingly, recalls can affect fewer products, as one example.

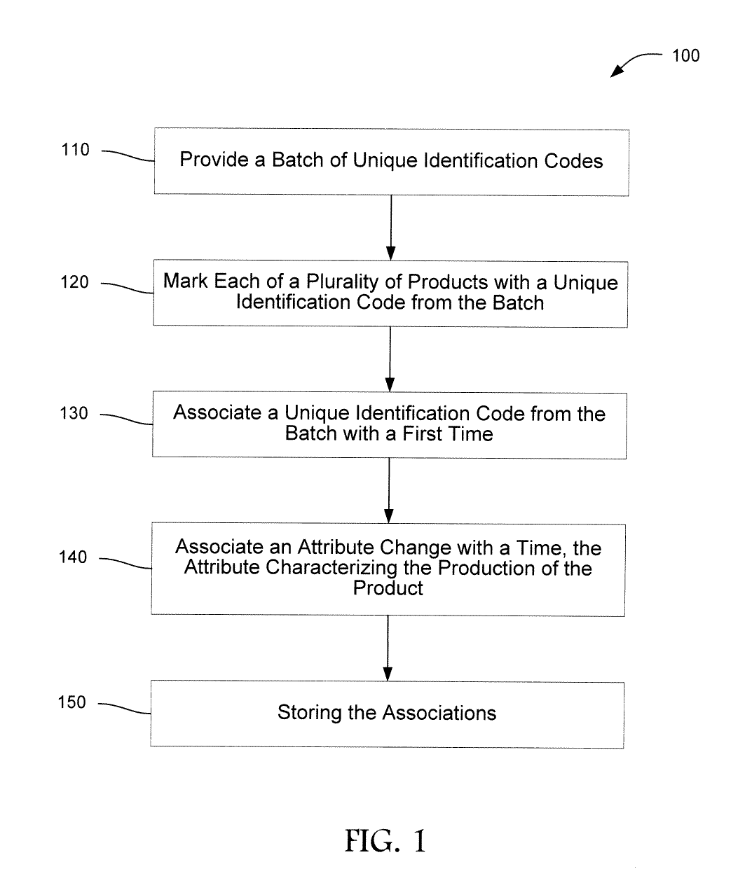

FIG. 1 shows a flowchart representation of an exemplary method 100 for marking products with unique identification codes and associating those unique identification codes with information about attributes that characterize the production of the products. The method 100 comprises a step 110 of providing a batch of unique identification codes, a step 120 of marking each of a plurality of products with a unique identification code from the batch, a step 130 of associating a unique identification code from the batch with a time, a step 140 of associating an attribute change with a time, the attribute characterizing the production of the product, and a step 150 of storing the associations. The associations that are stored can be used at a later date to determine, or at least estimate, the conditions under which a particular product with a unique identification code was produced and/or distributed.

In the step 100 a batch of unique identification codes is provided. Each unique identification code can comprise, for example, a different string of 12 or 24 numeric or alphanumeric characters. Within a batch, the unique identification codes are ordered, meaning that there is a first unique identification code, a second unique identification code, and so forth. Although the unique identification codes have an order within the batch, the characters in successive unique identification codes need not follow a pattern and can be unpredictable to the casual observer, in some embodiments.

The step 110 of providing the unique identification codes can comprise generating the unique identification codes and creating a record of the order of the unique identification codes, in some embodiments. In some embodiments, the unique identification codes are encrypted. Methods for unique identification code generation and encryption are described in U.S. Pre-Grant Publication No. 2007/0205258 entitled “System and Method of Product Information Coding and Authentication,” published on Sep. 6, 2007, which is incorporated herein by reference.

In some embodiments, the step 110 of providing the unique identification codes can comprise providing a roll of labels, where each label sequentially includes one unique identification code of the batch. In other words, successive labels on the roll include successive unique identification codes according to the order within the batch such that the first label includes the first unique identification code, the second label includes the second unique identification code, and so on. While rolls of labels are convenient, labels can also be provided on sheets, for example.

In other embodiments, the step 110 of providing the batch of unique identification codes includes providing a data file, where the data file includes the unique identification codes and an order of the unique identification codes. The data file can be provided, for example, over a network connection or on a computer readable medium such as a compact disk (CD) or flash drive. The data file can take the form of a table or list, in various embodiments.

After the unique identification codes have been provided in step 110, the method 100 comprises the step 120 of marking each of a plurality of products with a unique identification code from the batch. Examples of products include food items such as fresh fruits and vegetables, dairy products, bottled beverages, and canned or packaged foods, household products such as cleaners, pet products, and paper goods, personal care products such as deodorants and toothpaste, consumer electronics, semiconductors, pharmaceutical and medical devices, tax stamps, tobacco products, etc. The products are preferably marked at a production or packaging site before being shipped to wholesalers or retailers. For example, tomatoes can be marked as they are packed into crates in the field, beverage containers can be marked before or after filling,

In those embodiments where the unique identification codes are provided in step 110 on a roll of labels, the step 120 can comprise affixing a label from the roll to each of the plurality of products. Where the products proceed along an assembly line during packaging, for example, the labels can be affixed to the products as they pass a point along the assembly line. Thus, as each successive product passes the point, each receives the next label from the roll.

In other instances, where products such as oranges are packed in crates, or otherwise grouped together, labels can be affixed to the products in batches. In the examples of oranges in a crate, a first layer of oranges is placed in the crate, each is given a label, a second layer of oranges is placed in the crate, each is given a label, and so on. Here, the order with which the oranges in each layer are labeled is not significant. For reasons described below, applying some labels from the roll out of order and/or failing to use some labels on a roll can be tolerated, though not preferred.

In those embodiments where the unique identification codes are provided in step 110 in a data file, the step 120 can comprise reading the unique identification codes from the data file and marking the unique identification codes on each of the plurality of products according to the order. For example, as each successive product passes a point on an assembly line, each receives the next unique identification code from the data file according to the order. Products can be marked by various printing or scribing technologies such as inkjet printing, thermal transfer printing and laser scribing. It is also possible to print labels from the data file according to the order and affix the labels to the products.

The method 100 further comprises the step 130 of associating a unique identification code from the batch with a time. Associating the unique identification code from the batch with the time can encompass a variety of different scenarios. The time associated with the unique identification code can be the time that a product is marked with the unique identification code, a time after the product is marked, or even a time before the product is marked, in some situations. In some embodiments, the unique identification code is read from the label, or from a marking on the product, with a scanner.

In the example where products are marked by printing or scribing, the time at which each unique identification code is used to mark a product can be recorded. In various instances, however, the time associated with the unique identification code will be a time after the products are marked. While in some embodiments the unique identification code of every product is read after marking, and the time of the reading recorded, in other embodiments only some products are subsequently sampled. Here, times are recorded when the unique identification codes of the sampled products are read. Sampling can be performed at regular time intervals or after every n^{th} product, in various embodiments.

Likewise, in the example where labels from a roll are employed to mark products, the unique identification code of every product can be read from the label after marking, and the time of the reading recorded. Alternatively, only some products may be sampled, and the times are recorded when the unique identification codes of the sampled products are read from the labels. Less frequent sampling can be appropriate where the product has limited value. For example, labeled baskets of strawberries are sampled at a rate of about one in 100. In still other cases, the unique identification codes are read from labels before being affixed to the products, either for every product or with some reduced frequency.

The method 100 further comprises the step 140 of associating an attribute change with a time, the attribute characterizing the production of the product. Examples of attributes include product attributes which are generally static, and line (“just-in-time”) attributes which are generally dynamic. Product attributes can be predefined at the time that the batch of unique identification codes is generated, such as the product Stock Keeping Unit (SKU), the Universal Product Code (UPC), the brand and company, an image of the product, and pointers or links to other information such as nutritional information and Material Safety Data Sheets (MSDSs).

Examples of line attributes include the date of production, production line, operator, farm, harvesting crew, lot number, weather conditions, destination, customer order number, the date and time of arrival of goods and materials at points along the manufacturing and distribution chains such as distribution hubs, wholesalers, retailers, the date of sale of the product, when sources of raw materials are changed, when formulations are changed, storage conditions, and generally whenever process conditions change in a recordable manner. Attributes characterize the production of the product in that they represent information about production and distribution conditions at the time a particular unit of the product was coming to market. Knowing when an attribute changed can be valuable when attempting to isolate a source of a problem.

In step 140, the time that is associated with the attribute change can be the time that the change affects products being manufactured. For instance, where the temperature of a chemical reactor is monitored in real time, a change in the temperature at a given time affects the product being manufactured as of that time. On the other hand, the time that is associated with the attribute change can be the time that a change is implemented, even though the attribute change does not immediately affect the products being manufactured. For example, when a new lot of paint is first attached to a supply line of a paint sprayer, paint in the supply line from the prior lot has to be used before the new paint starts to be applied to the products being manufactured. In those instances where the attribute change does not immediately affect the products being manufactured there can be a time delay further associated with the time and attribute change. In the example of the paint sprayer, the delay between when a new lot of paint is attached to the supply line and when paint from the new lot is first applied to products can be 5 minutes, for instance.

Additionally, many attribute changes have an uncertainty that can also be associated with the time and the attribute change. Returning to the paint sprayer example, even if it is known that it takes approximately 5 minutes for paint to traverse the supply line to the sprayer, due to mixing there may be a one minute period during which paint from both the old and new lots are applied. In the case of the chemical reactor noted above, the temperature change is not instantaneous and occurs over some period of time. The attribute itself, both before and after the change can also be associated with the time and/or the attribute change.

In step 150 the associations made in steps 130 and 140 are stored, for example, as records in a database, though the particular data structure used to store the associations is not significant. These steps also need not happen in the sequence shown in FIG. 1 and in various instances occur in different orders. For example, when a unique identification code is read with a scanner at a time, a record of the association of the time with the unique identification code can be immediately stored. Here, steps 130 and 150 occur together. On the other hand, in the paint sprayer example, the time that a paint lot is changed can be noted by an operator on a log sheet or by scanning a barcode on the new lot, thus associating the two, and subsequently the association of the time and the lot change are entered into a spreadsheet to store a record of the association. Here, step 140 occurs before step 150. It will be appreciated, moreover, that step 140 can occur before step 130.

In general, it will be understood that the process of making and storing associations between times and unique identification codes, and the process of making and recording associations between times, attribute changes, the attribute before and after the change, delays, and uncertainties are independent of one another and occur in parallel. Thus, it will be understood that the associations made in steps 130 and 140 need not be stored together in a single database but can be stored separately in different databases.

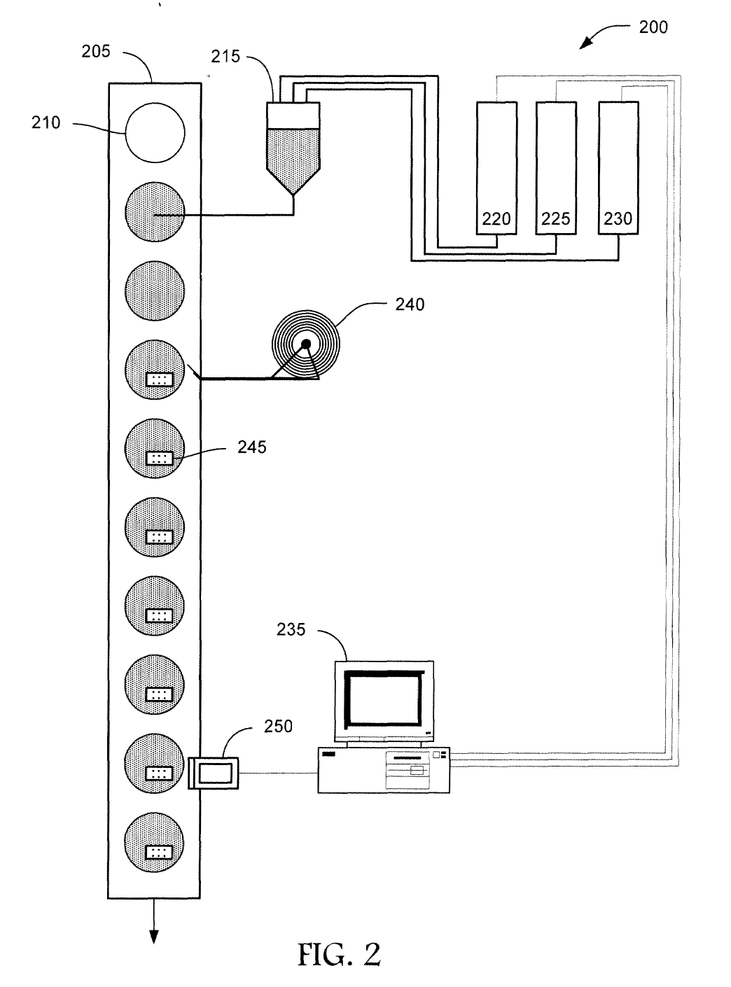

FIG. 2 schematically illustrates an exemplary system 200 for performing an embodiment of the method 100. The system 200 includes a conveyor 205 that carries products 210 through a production process. In this particular example, the products 210 are bottles of a beverage that are filled from a mixing vessel 215 at a production point. Three liquid components are mixed in the mixing vessel 215 to create the beverage, each component stored in one of tanks 220, 225, 230. Whenever a tank 220, 225, 230 is refilled, notification of the change is sent to a computing system 235, such as a PC or server, that records the change in association with the time of the change. The computing system 235 may also store information about the component that was newly added, such as a lot number, in association with the change and the time of the change. The computing system 235 may also maintain a record of the delays between when tanks 220, 225, 230 are refilled and when their respective components reach the mixing vessel 215. The computing system 235 may also maintain a record of the length of time required for any new component added to the mixing vessel 215 to substantially displace the old component.

After the products 210 are filled, the products are labeled from a roll of labels 240, where each label 245 includes a unique identification code. In some embodiments, when the roll of labels 240 is provided, a data file is also provided to the computing system 235 that includes the unique identification codes and their order on the roll 240. In other embodiments, the unique identification codes and their order are maintained elsewhere. After the products 210 are labeled, the labels 240 are sampled at a sampling point by a scanner 250, for example, and the computing system 235 records the unique identification code in association with the time of the reading. The time that typically elapses between when the products 210 are filled at the production point and when the products 210 pass the sampling point is a delay that can be employed in further methods described below.

The frequency of sampling at the sampling point can be set to provide a desired confidence level. The ability to estimate the time that a product 210 passed the sampling point, where the product 210 was not sampled, relies on how close in the order of the batch from which the non-sampled product 210 came, to a sampled product 210. More frequent sampling yields higher confidence. Statistical methods can be readily applied to select appropriate sampling rates for different products 210.

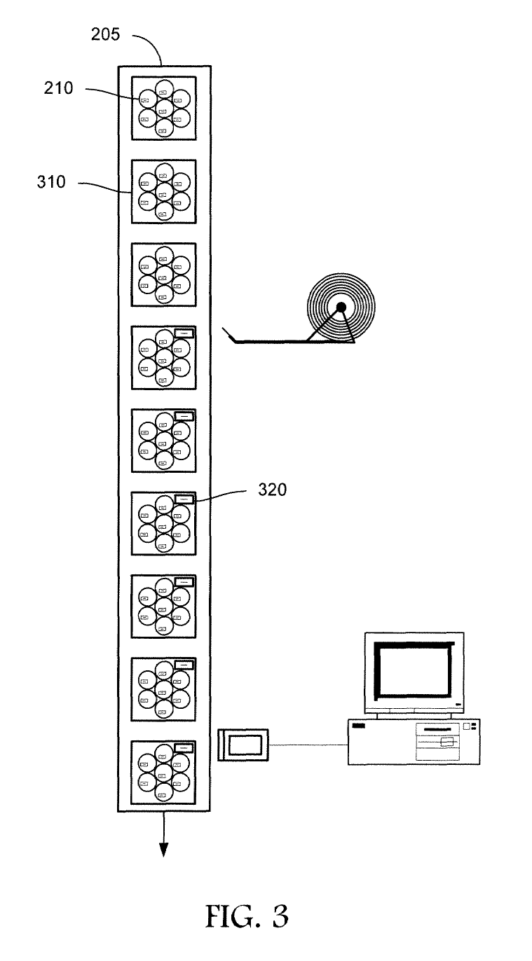

FIG. 3 schematically illustrates an exemplary system 300 for performing another embodiment of the method 100. Here, the conveyor 205 carries cases 310 of the products 210, packed after the products 210 have been marked with labels 245. Each case 310 is marked with a unique identification code 320 from a different batch than that used to mark the products 210. It should be appreciated that the labels 245 are applied to the products, in some embodiments, after the products 210 have been packed into the cases 310. The unique identification codes 320 can be sampled as described above.

Also in some embodiments, the sampling frequency is high enough that at least one label 245 of a product 210 in each case 310 is sampled, for example the first or last product 210 in each case 310. In these instances, the unique identification codes (“children”) for the labels 245 on the products 210 within a particular case 310 can inherit from the unique identification code 320 (“parent”) of that case 310.

In a harvesting operation, for example, information at the level of the case 310, which can be both attributes and attribute changes such as field identification, crew shift identification, weather conditions, variety, and distribution, are common to, and therefore inherited by, all of the children products 210 within a particular parent case 310. After the products 210 are removed from the case 310, further attributes can be associated with the individual products 210. For instance, the time each product 210 is sold and from what location, and the time of any inquiry related to the unique identification code 245.

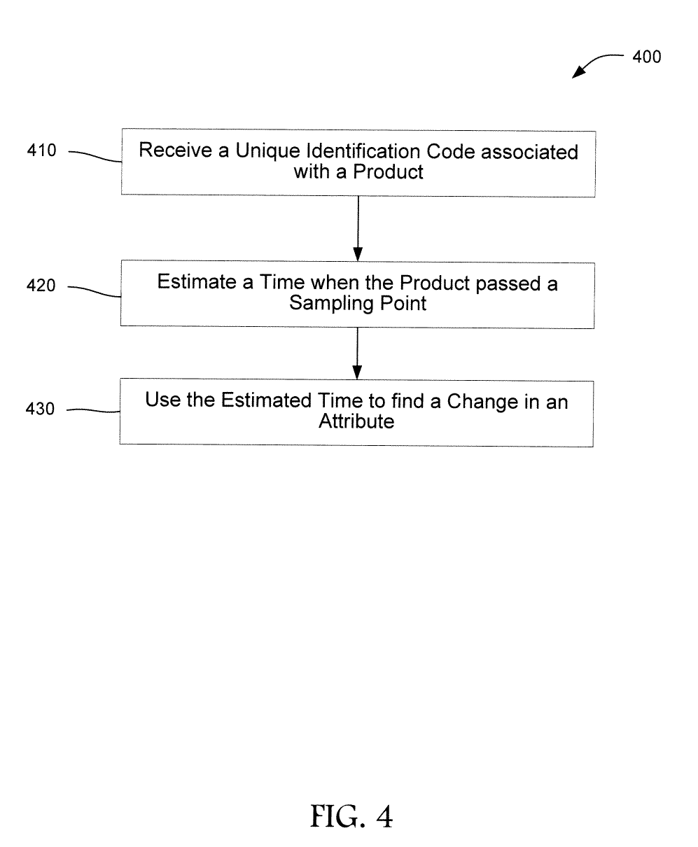

FIG. 4 shows a flowchart representation of another exemplary method 400. The method 400 comprises a step 410 of receiving a unique identification code associated with a product, a step 420 of estimating a time when the product passed a sampling point, and a step 430 of using the estimated time to find a change in an attribute. In the step 420, the estimated time is determined by comparing the unique identification code to records of the times associated with other unique identification codes from a same batch.

The unique identification code is received in the step 410. For example, a consumer takes a product to a kiosk in a market and scans the unique identification code. The kiosk transmits the unique identification code, which is received by a computing system, such as a PC or server (though not necessarily the computing system 235 (FIG. 2)). In some embodiments, the method 400 also comprises decrypting the received unique identification code.

Once the unique identification code has been received, an estimated time is generated in step 420. Here, the estimated time represents when the product most likely passed a sampling point. This time is estimated by comparing the unique identification code to records of the times associated with other unique identification codes from the same batch as the received unique identification code. The comparison is performed by first determining the batch that the unique identification code came from. Methods for determining a batch based on a unique identification code are described in U.S. Pre-Grant Publication No. 2007/0205258, noted above.

Next, the unique identification code is compared to records of the times associated with sampled unique identification codes from a same batch. First, the position of the received unique identification code is determined within the order of the batch. Next, with reference to the records of times associated with sampled unique identification codes, the sampled unique identification code that is closest in the order to that of the received unique identification code is determined. In some embodiments, where high confidence is not required, the estimated time is merely the time associated with the nearest sampled unique identification code. For greater confidence, the estimated time can be extrapolated as being proportionally between the times associated with the nearest two sampled unique identification codes.

In some situations, records of associations between sampled unique identification codes and the times when those unique identification codes were sampled may include irregularities that can cause errors when estimating the time at which a product passed a sampling point, but that also can be corrected for if recognized. Accordingly, in some embodiments of the method 400, the method 400 further comprises performing an analysis for irregularities, such as for missing data and for data that is out of order or in reverse order. Where such irregularities are found, the step 420 of estimating a time when the product passed the sampling point can further comprise correcting for the irregularity.

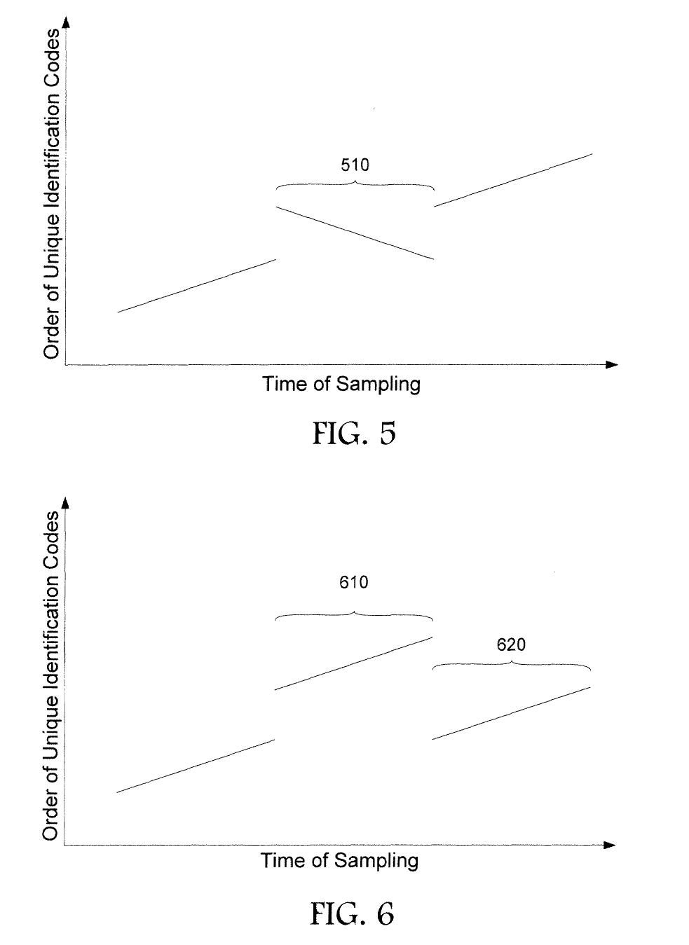

FIGS. 5 and 6 illustrate two examples of such irregularities. In both examples, a number of unique identification codes from a batch were sampled, each at a particular sampling time. FIGS. 5 and 6 each shows a plot of the times at which the unique identification codes were sampled as a function of their order in the batch, and serve as examples of one kind of an analysis for irregularities that can be performed. In FIG. 5, it can be seen that over a segment 510 of the batch, the products with unique identification codes within the segment 510 were apparently either marked according to the order of the batch and sampled in reverse order or were marked in reverse order and sampled in the correct order. In some instances, specifics of the production system can clarify between these alternatives. For example, where unique identification codes are marked on products from a data file, it is more likely that the order of the products became reversed before being sampled. FIG. 6 shows the same kind of an analysis for irregularities that was performed in FIG. 5, but in this example two segments 610 and 620 are switched. Thus, if a product is found to have an associated unique identification code that falls within a reversed segment 510 in FIG. 5, or a transposed segment 610 or 620 in FIG. 6, the step 420 of estimating the time when that product passed the sampling point can further comprise correcting for the irregularity.

In some embodiments, the method 400 can also comprise estimating when the product passed a production point. This can be accomplished, for example, by adjusting the estimated time for the sampling point by a transit time. Adjusting can comprise adding or subtracting the transit time, depending on whether products pass the production point before the sampling point as in FIG. 2, or are sampled before reaching the production point. Here, the transit time represents the amount of time products spend in transit between the production and sampling points.

Returning to FIG. 4, in step 430 the estimated time, either for passing the sampling point or the production point, is used to find the change in the attribute. Referring again to FIG. 2, to trace back to a source of a contamination found in several products 210, records stored by the computing system 235 can be searched to find attributes that changed within a period of time before the estimated time. Here, the estimated time is compared to the time of an attribute change to determine whether the attribute change took place before the contaminated product 210 was either sampled or filled. Having more than one contaminated product 210 can improve the ability to distinguish between possible attribute changes that might be responsible.

In determining whether a problem with a product 210 developed before or after some attribute change, it can be advantageous to also account for any delay between the time of the attribute change and the time when the attribute change began to actually affect products at the production point. Thus, the time of the attribute change can be adjusted by the delay. As noted above, an uncertainty that is associated with the attribute change can also be added to the time of the attribute change.

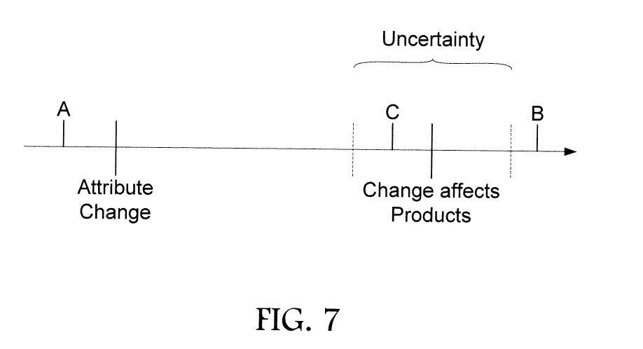

The application of method 400 during a product recall is described below with reference to FIG. 7. In the case of a recall, it would be advantageous to be able to avoid recalling products that do not pose a risk. With reference to FIG. 2, if the source of the contamination has been previously traced to a lot of a component that was first added to tank 230 at the time of a recorded attribute change, the recall can exclude those products 210 that were filled before the time of the attribute change. A product 210 subject to a possible recall could be scanned, for example at a kiosk, to determine whether the particular product is safe or not. The time is when the particular product 210 passed the sampling point is first estimated, then the time at which the product 210 was filled at the production point is determined by subtracting the transit time from the estimated sampling time.

FIG. 7 shows a timeline for determining product safety during the recall. In FIG. 7, three possible times (A, B, and C) at which the product 210 may have been filled are compared against the time of the attribute change, modified by any delay and uncertainty. If the time that the product 210 was filled (time A) was before the time of the attribute change, without modification, the product is safe. If the time that the product 210 was filled was after the time of the attribute change, as modified by the delay (time B), the product is unsafe. If the time that the product 210 was filled was within the uncertainty period and before the time of the attribute change, as modified by the delay (time C), the product could potentially be safe, but for the purposes of the recall would be considered unsafe.

As noted previously, in some embodiments the method 400 can also comprise comparing the estimated time to a record of an attribute without particular regard for whether the attribute changed. For example, the consumer may inquire at the kiosk regarding the date that a piece of fruit was harvested. By consulting a database, or some other data structure used to store associations between sampled times and attributes, the date that the piece of fruit was harvested can be estimated by the methods describe above.

Embodiments of various methods described above can be stored as a set of instructions on machine readable media. The instructions can be executed to cause a machine to perform the method.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
providing a batch of unique identification codes;
marking each of a plurality of products with a unique identification code from the batch;
associating a unique identification code from the batch with a first time;
associating an attribute change with a second time, the attribute characterizing the production of the product; and
storing the associations.

2. The method of claim 1 wherein providing the batch of unique identification codes includes generating the unique identification codes of the batch and creating a record of the order of the unique identification codes.

3. The method of claim 1 wherein providing the batch of unique identification codes includes providing a roll of labels, each label sequentially including one unique identification code of the batch according to an order of the unique identification codes within the batch.

4. The method of claim 3 wherein marking each of the plurality of products with the unique identification code from the batch includes affixing a label from the roll to each of the plurality of products.

5. The method of claim 1 wherein providing the batch of unique identification codes includes providing a data file, the data file including the unique identification codes and an order of the unique identification codes.

6. The method of claim 5 wherein marking each of the plurality of products with the unique identification code from the batch includes reading the unique identification codes from the data file and printing the unique identification codes on each of the plurality of products according to the order.

7. The method of claim 5 wherein marking each of the plurality of products with the unique identification code from the batch includes reading the unique identification codes from the data file and scribing the unique identification codes on each of the plurality of products according to the order.

8. The method of claim 1 wherein associating the unique identification code from the batch with the first time includes recording when the unique identification code was marked on the product.

9. The method of claim 1 wherein associating the unique identification code from the batch with the first time includes recording when the unique identification code was read from the product.

10. The method of claim 1 further comprising associating a delay with the second time.

11. The method of claim 1 further comprising associating an uncertainty with the second time.

12. The method of claim 1 further comprising marking each of a plurality of cases of the products with a unique identification code from a batch different than the batch used to mark the products themselves.

13. A method comprising:
receiving a unique identification code associated with a product;
estimating a time when the product passed a sampling point by comparing the unique identification code to records of the times associated with other unique identification codes from a same batch; and
using the estimated time to find a change in an attribute.

14. The method of claim 13 further comprising decrypting the unique identification code.

15. The method of claim 13 further comprising performing an analysis for an irregularity in the records of associations between sampled unique identification codes and the times when those unique identification codes were sampled.

16. The method of claim 15 wherein estimating the time when the product passed the sampling point further comprises correcting for an irregularity.

17. The method of claim 13 further comprising generating an estimated time representing when the product passed a production point by adjusting the estimated time for the sampling point by a transit time.

18. The method of claim 13 wherein using the estimated time to find the change in the attribute includes searching records of associations between times and attribute changes for an attribute change at a time before the estimated time.

19. The method of claim 13 wherein using the estimated time to find the change in the attribute includes adjusting the time of an attribute change by a delay.

20. The method of claim 13 wherein using the estimated time to find the change in the attribute includes adding an uncertainty to the time of an attribute change.

21. A machine readable media having stored thereon a set of instructions, which can be executed to cause a machine to perform a method comprising:
receiving a unique identification code associated with a product;
estimating a time when the product passed a sampling point by comparing the unique identification code to records of the times associated with other unique identification codes from a same batch; and
using the estimated time to find a change in an attribute.
